(19) United States
(12) Patent Application Publication
(10) Pub. No.: US 2023/0117842 A1
(43) Pub. Date: Apr. 20, 2023

(54) QUALITY OF SERVICE BUFFER STATUS REPORT OPERATION

(71) Applicants: SONY GROUP CORPORATION, Tokyo (JP); SONY CORPORATION OF AMERICA, New York, NY (US)

(72) Inventors: Liangxiao Xin, Santa Clara, CA (US); Mohamed Abouelseoud, Burlingame, CA (US); Li-Hsiang Sun, San Jose, CA (US); Qing Xia, San Jose, CA (US)

(73) Assignees: SONY GROUP CORPORATION, Tokyo (JP); SONY CORPORATION OF AMERICA, New York, NY (US)

(21) Appl. No.: 17/936,755

(22) Filed: Sep. 29, 2022

Related U.S. Application Data
(60) Provisional application No. 63/324,701, filed on Mar. 29, 2022.
(60) Provisional application No. 63/262,801, filed on Oct. 20, 2021.

(51) Int. Cl. H04W 28/02

(52) U.S. Cl. CPC H04W 28/0278; H04W 28/0268

(57) ABSTRACT

A buffer status reporting mechanism, such as within a buffer status request poll (BSRP), in which the Access Point (AP) communicates the specific type of information that the non-AP station (STA) is to communicate back, such as within a buffer status report (BSR), about the buffers. The AP specified requirements for the BSR being characteristics of: access categories (ACs), traffic identifiers (TIDs), traffic streams, traffic directions, and/or types of traffic and quality of service (QoS) requirements which allow the AP to properly arrange transmissions to satisfy QoS requirements.

### CROSS-REFERENCE TO RELATED APPLICATIONS

This application claims priority to, and the benefit of, U.S. Provisional pat. Application Serial No. 63/324,701 filed on Mar. 29, 2022. This application also claims priority to, and the benefit of, U.S. Provisional Pat. Application Serial No. 63/262,801 filed on Oct. 20, 2021, each incorporated herein by reference in their entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless local area networks operating under IEEE 802.11, and more particularly to a buffer status collection mechanism which allows an Access Point station to properly arrange transmissions, such as of non-AP stations, such as to satisfy Quality of Service (QoS) requirements.

### 2. Background Discussion

In current technologies, the AP has a limited ability to adjust transmissions toward meeting QoS requirements. These limitations are particularly problematic when handling latency sensitive traffic, as the data can become expired (no longer valid) even before it is sent.

Accordingly, a need exists for protocols which enhance the abilities of the AP to control transmissions to meet QoS requirements. The present disclosure overcomes those issues and provides additional communication benefits.

### BRIEF SUMMARY

A wireless local area network communication apparatus, method and protocol are described which enhance network communications, in particular in regard to fulfilling quality-of-service (QoS) requirements. For example, some traffic can be subject to latency constraints, whereby the data loses its value if the constraint is exceeded.

In this protocol wireless communication are performed in an IEEE 802.11 protocol between stations of a wireless communication network.

The described protocol describes a form(s) of specific Buffer Status Report (BSR) and operations making use of the specific BSR. The specific BSR is either received in response to an AP transmitting a specific Buffer Status Request Pole (BSRP) to the non-AP STA, or is received as an unsolicited specific BSR from a non-AP STA. The specific BSR contains specific buffer characteristics, such as: access categories (ACs), traffic identifiers (TIDs), traffic streams, traffic directions, types of traffic and quality of service (QoS) requirements.

In response to the specific BSR information received from the non-AP STA, the AP arranges transmissions to optimize communications, such as in satisfying QoS requirements. The present disclosure exemplifies instances of how this information is utilized, such as for handling latency sensitive traffic.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 and FIG. 2 are data field diagrams depicting a Medium Access Control (MAC) frame header in FIG. 1, and its frame body in FIG. 2.

FIG. 3 is a data field diagram depicting a Buffer Status Report (BSR) control subfield as carried by an A-Control subfield of the High Efficiency (HE) variant High Throughput (HT) control field, as defined in IEEE 802.11ax.

FIG. 4 is a data field diagram of a Trigger Frame (TF).

FIG. 5 is a data field diagram of subfield content within the Common Information field in the Trigger frame of FIG. 4.

FIG. 6 is a data field diagram of subfield content within the User Information field in the Trigger frame of FIG. 4.

FIG. 7 is a hardware block diagram of station (STA) hardware according to at least one embodiment of the present disclosure.

FIG. 8 is a hardware block diagram of Multiple-Link Device (MLD) hardware according to at least one embodiment of the present disclosure.

FIG. 9 is a flow diagram of an AP sending a specific Buffer Status Report Pole (BSRP) to request a specified (augmented) Buffer Status Report (BSR) from its associated STAs, according to at least one embodiment of the present disclosure.

FIG. 10 is a flow diagram of a non-AP STA sending a specific Buffer Status Report (BSR) to report its buffer status after it receives a specific BSRP with specific requirements from its associated AP, according to at least one embodiment of the present disclosure.

FIG. 11 is a data field diagram of a trigger dependent User Info subfield in the user info field of a specific BSRP Trigger frame, according to at least one embodiment of the present disclosure.

FIG. 12 is a data field diagram of a specific BSR control subfield, denoted by QoS BSR control subfield, according to at least one embodiment of the present disclosure.

FIG. 13 is a data field diagram of specific QoS BSR control subfields, according to at least one embodiment of the present disclosure.

FIG. 14 is a network topology for use in the communication examples according to at least one embodiment of the present disclosure.

FIG. 15 is a communications diagram of an AP sending a specific BSRP trigger frame with specific requirements for the specific BSR, according to at least one embodiment of the present disclosure.

FIG. 16 is a communications diagram of a STA reporting TXOP duration requested for P2P traffic in its buffer, according to at least one embodiment of the present disclosure.

FIG. 17 is a communications diagram of an AP requesting buffer status for P2P traffic only, according to at least one embodiment of the present disclosure.

FIG. 18 is a communications diagram of an AP sending a specific BSRP trigger frame to request buffer status of multiple ACs, according to at least one embodiment of the present disclosure.

FIG. 19 is a communications diagram of a PPDU carrying multiple frames with QoS control fields, according to at least one embodiment of the present disclosure.

### DETAILED DESCRIPTION

### 1. Introduction

In the current 802.11 be specification, the Access Point (AP) can collect buffer status of the non-AP stations (STAs).

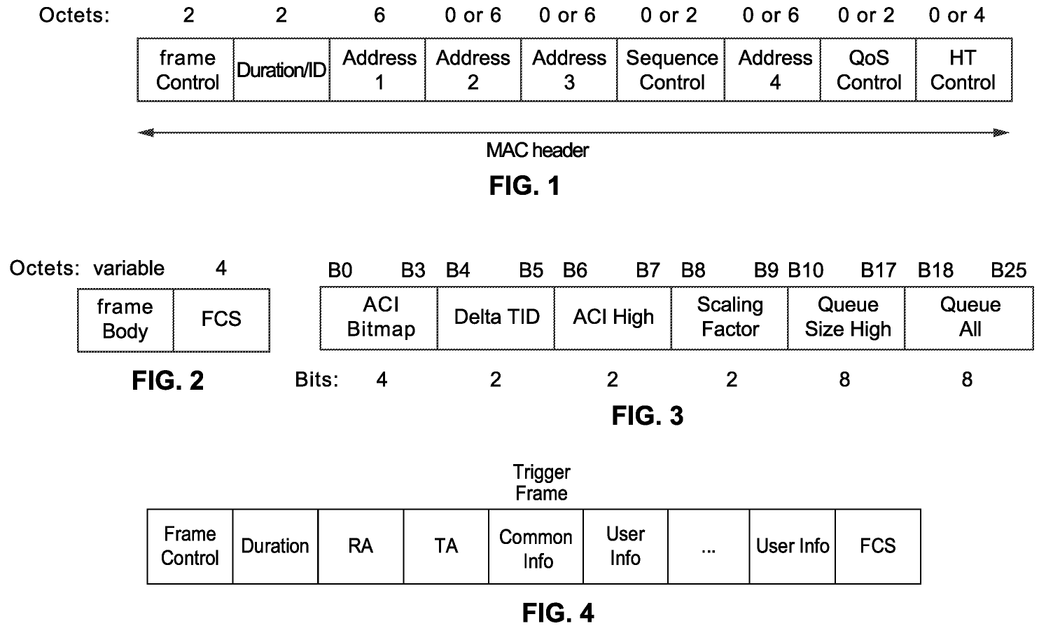

FIG. 1 and FIG. 2 depict a Medium Access Control (MAC) frame header in FIG. 1, and its frame body and its Frame Check Sequence (FCS). An AP sends a Buffer Status Report Poll (BSRP) Trigger Frame (TF) to request a Buffer Status Report (BSR) from the non-AP STAs. After receiving a BSRP trigger frame, the non-AP STA shall include one or more Quality of Service (QoS) Null frames with QoS Control fields and/or BSR Control subfields in a High Efficiency (HE) Trigger Based (TB) Physical Layer Protocol Data Unit (PPDU). The BSR can be carried in the BSR control subfield and the QoS control field of the frames.

The QoS control field reports the buffer status at the Access Class (AC) level and can be carried in QoS data or QoS Null frames. The BSR control subfield reports the buffer status of a Traffic Identifier (TID) and can be carried in the High Throughput (HT) control field in the QoS data or QoS Null frame or management frame. A non-AP STA can send an unsolicited BSR to the AP. For unsolicited BSRs, the non-AP STA can aggregate one or more QoS data frames or QoS Null frames carrying QoS control fields in an Aggregate MAC Protocol Data Unit (A-MPDU) to report the buffer status for different TIDs.

### 1.1. BSR Control Field

FIG. 3 depicts a BSR control subfield as carried by an A-Control subfield of the High Efficiency (HE) variant HT control field, which is defined in IEEE 802.11ax. The BSR control subfield is able to report the buffer status of one or more ACs.

In a MAC frame of IEEE 802.11, the QoS control field can be used to report the Queue Size and the TXOP Duration Requested. The following describes what the control fields are for a given frame type or sub-type in the QoS Control field (Bits 0-15). It should be noted that in the following descriptions Bits 0-3 are always TID and Bits B5-B6 are an Acknowledgement (Ack) Policy Indicator.
(1) QoS Contention Free (CF)-Poll and QoS CF-Ack+CF-Poll frames sent by the Hybrid Coordinator (HC), which is the AP in these examples: Bit 4 = End Of Service Period (EOSP); Bit 7 = Reserved; Bits 8-15 = Transmit Opportunity (TXOP) Limit;
(2) QoS Data+CF-Poll and QoS Data+CF-Ack +CF-Poll frames sent by HC: Bit 4 = EOSP; Bit 7 = A-MDSU Present; Bits 8-15 = TXOP Limit;
(3) QoS Data+QoS Data+CF-Ack frames sent by HC: Bit 4 = EOSP; Bit 7 = A-MDSU Present; Bits 8-15 = AP PS Buffer State;
(4) QoS Null frames sent by HC: Bit = EOSP; Bit 7 = Reserved; Bits 8-15 = AP Power Save (PS) Buffer State;
(5) QoS Data+QoS Data+CF-Ack frames sent in a non-mesh Basic Service Set (BSS) by non-AP STAs that are not a Transmit Power Used (TPU) buffer STA or a TPU sleep STA: If Bit 4 = 0: then Bit 7 = A-MDSU Present, and Bits 8-1= TXOP Duration requested; otherwise, if Bit 4 = 1: then Bit 7 = A-MDSU Present, and Bits 8-1= Queue size;
(6) QoS Null frames sent in a non-mesh BSS by non-AP STAs that are not a TPU buffer STA or a TPU sleep STA: If Bit 4 = 0: then Bit 7 = Reserved, and Bits 8-15 = TXOP Duration requested; otherwise, if Bit 4 = 1 : then Bit 7 = Reserved, and Bits 8-15 = Queue size;
(7) QoS Data and QoS Data+CF-Ack frames sent by TPU buffer STA; Bit 4 = EOSP; Bit = A-MDSU Present; and Bits 8-15 = Reserved;
(8) QoS Null frames sent by TPU buffer STAs: Bit 4 = EOSP; Bit 7 = Reserved; and Bits 8-15 = Reserved;
(9) QoS Data and QoS Data + CF-Ack frames sent by TPU sleep STAs: Bit 4 = Reserved; Bit 7 = A-MDSU Present; and Bits 8-15 = Reserved;
(10) QoS Null frames sent by TPU sleep STAs: Bit 4 = Reserved; Bit 7 = Reserved; and Bits 8-15 = Reserved;
(11) All frames sent by mesh STAs in a mesh BSS: Bit 4 = EOSP; Bit 7 = A-MDSU Present; Bit 8 = Mesh Control present; Bit 9 = Mesh Power Save Level; Bit 10 = Receiver Service Period Initiated (RSPI); Bits 11-15 = Reserved.

### 1.2. BSR Trigger Frame

In IEEE 802.11 ax, the AP can send a BSRP trigger frame to request BSRs from the non-AP STAs.

FIG. 4 depicts a Trigger Frame (TF) having the following fields: Frame Control, Duration, Receiver Address (RA), Transmitter Address (TA), Common Information, User Information, and FCS.

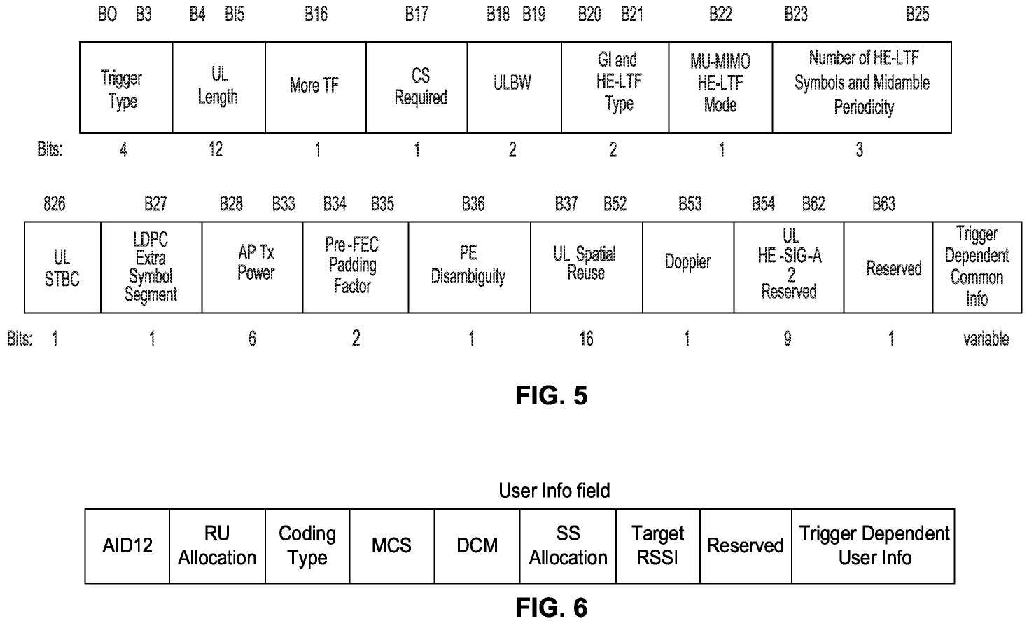

FIG. 5 depicts the subfield content within the Common Information field of FIG. 4 having the following subfields: Trigger type, UL Length, More TF, CS Required, UL Bandwidth (BW), GI and HE-LTF Type, MU MIMO HE-LTF Mode, Number of HE-LTF symbols and mid-amble periodicity, UL STBC, LDPC Extra Symbol Segment, AP TX Power, Pre-FEC Padding Factor, PE Disambiguity, UL Spatial Reuse, Doppler, UL High Efficiency Signal (HE-SIG)-A2 Reserved, Reserved, and Trigger Dependent Common Info.

The trigger type field in the common info field of the trigger frame indicates it is a BSPR trigger frame.

FIG. 6 depicts the subfield content of the User Information field of the Trigger frame of FIG. 4, having the following subfields: Association Identification (AID12) (12 least significant bits of the intended beamformee’s association ID), Resource Unit (RU) Allocation, Coding Type, Modulation Coding Scheme (MCS), Dual Carrier Modulation (DCM), Spatial Stream (SS) Allocation, Target Received signal strength indicator (RSSI), Reserved and Trigger Dependent User Information.

It should be noted that there is no Trigger dependent common info field in the common info field or the trigger dependent user info field in the user info field when the trigger frame is a BSRP.

### 2. Present Disclosure

### 2.1. Problem Statement

The current implementation of the buffer reporting mechanisms constrain communications efficiency. In particular, the present disclosure notes that the present buffer status report request poll (BSRP) cannot specify requirements for the buffer status report which might be most useful for the AP to receive. It should be noted that the AP may receive buffer status reports carried by the QoS control field, or BSR control subfield in the HT control field in a frame from the non-AP STA. The BSR control subfield in the HT control field cannot differentiate the traffic from different TIDs of the same AC. However, the AP could be significantly aided by being able to obtain buffer status per TID in some scenarios, such as during Multi-Link Operations (MLOs), so that it can distribute the buffer of different TIDs to the corresponding links according to the TID-to-link mapping setting of the AP.

The current Buffer Status Report (BSR) cannot differentiate the Peer-2-Peer (P2P) traffic buffer and Uplink (UL) traffic buffer in the same TID of a non-AP STA. It is better for the non-AP STA to report the queue size of UL traffic buffer, instead of the TXOP required time of P2P traffic buffer, so that enough channel resource is allocated by the AP for transmitting P2P traffic. In particular, the MCS of the transmitting UL traffic buffer is decided by the AP. The AP estimates and allocates the UL transmission time when it launches a trigger-based UL transmission. Also, the MCS of the transmitting P2P traffic buffer is decided by the non-AP STA, but not the AP. Therefore, the AP cannot estimate the TXOP time required for transmitting the P2P traffic based on the queue size of the P2P traffic. Alternatively, the non-AP STA estimates the TXOP required time for its P2P traffic based on the MCS. If the non-AP STA reports the TXOP required time for its P2P traffic to the AP, then the AP can allocate TXOP time for the non-AP transmitting the P2P traffic.

The current buffer status report cannot report the buffer status per Stream Classification Service (SCS) traffic stream. The traffic of a SCS traffic stream may have different QoS requirements, such as Medium Access Control (MAC) Service Data Unit (MSDU) expiration time, than the other traffic in the same TID. Thus, it is beneficial to report the buffer status of the SCS traffic stream separately in order to satisfy the QoS requirement of the traffic.

### 2.2. Contribution of the Present Disclosure

By utilizing the teachings of the present disclosure, the AP can indicate its requirements for the buffer status report from the non-AP STAs. That is to say that the AP can specify the format of the buffer status report from the non-AP STAs, such as the following. The AP can specify that it requires the buffer status at the AC level, TID level, or Traffic Stream (TS) (e.g., SCS) level. The AP can specify the type of traffic, such as latency sensitive traffic or regular traffic, that it requires the buffer status for. The AP can specify the direction of traffic, such as UL, P2P, or UL+P2P, it requires to get buffer status of. The AP can specify whether the QoS requirement, such as the MSDU expiration time, of the buffer is needed in the buffer status report.

To differentiate from the use of standard BSRP and BSR, the present disclosure will refer to “specific BSRP” and “specific BSR” as the present disclosure uses a form of these that is augmented to provide additional specificity.

By utilizing the proposed disclosure, the non-AP STA can report the buffer status of P2P traffic and UL traffic in the same TID or AC to its associated AP separately, such as exemplified by the following. When the non-AP STA reports the queue size (in units of bits/bytes) of UL traffic to the AP, the AP can launch a trigger-based UL transmission for those UL traffic. When the non-AP STA reports the TXOP required time of the P2P traffic to the AP, the AP can share its TXOP time as required with the non-AP STA and the non-AP STA can transmit P2P traffic of the TID during the shared TXOP time. The non-AP STA may report the TXOP required time of the UL traffic. Then, the AP can share its TXOP time as required with the non-AP STA and the non-AP STA can transmit UL traffic of the TID during the shared TXOP time. The non-AP STA may report the TXOP required time of a traffic stream (e.g., a SCS traffic stream), a TID or an AC, including UL traffic and P2P traffic.

By utilizing the proposed technologies, the non-AP STA can report the QoS requirement, such as MSDU expiration time, of the buffer to its associated AP. The AP can arrange the transmission to satisfy the QoS requirements of that traffic. For example, the AP should finish the transmission of the traffic before the MSDU expiration time of the traffic.

### 3. Communication Station (STA and MLD) Hardware

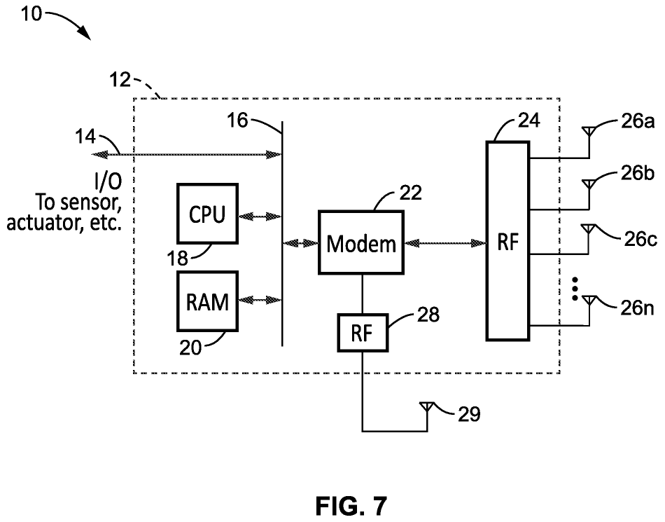

FIG. 7 illustrates an example embodiment 10 of STA hardware configured for executing the protocol of the present disclosure. An external I/O connection 14 preferably couples to an internal bus 16 of circuitry 12 upon which are connected a CPU(s) 18 and memory (e.g., RAM) 20 for executing a program(s) which implement the communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with other AP, coordinator, coordinatee, AP in an OBSS, STA in an OBSS, and so forth), depending on what role it is performing in the current communication context.

Thus, the STA HW is shown configured with at least one modem, and associated Radio-Frequency (RF) circuitry for providing communication on at least one band.

It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware as shown in the figure, can be combined into a multi-link device (MLD), which typically will have a processor and memory for coordinating the activity, while there is not always a need for a separate CPU and memory for each STA within the MLD.

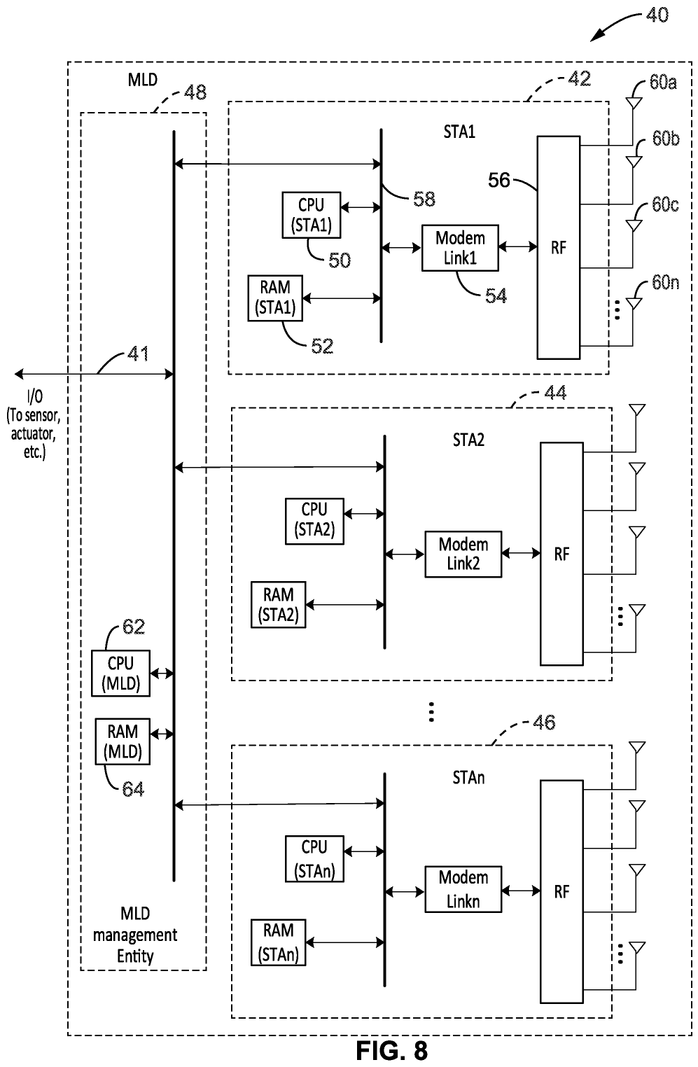

FIG. 8 illustrates an example embodiment 40 of a multi-link device (MLD) hardware configuration. A soft AP MLD is a MLD that consists of one or more affiliated STAs, which are operated as APs. The soft AP MLD should support multiple radio operations, such as on 2.4 GHz, 5 GHz and/or 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a Non-Simultaneous Transmission and Reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implement communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 4. QoS BSR Operation

The present disclosure describes QoS BSR operations which allow an AP to specify its requirement of the format of a specific BSR to collect from the non-AP STAs. For example, the AP can specify that this ‘specific’ BSR should report buffer status per AC, per TID, or per traffic stream. The AP can specify that the specific BSR should include the QoS status of the buffer, for example the expiration time of the MSDU lifetime, or the delay bound as indicated in the corresponding QoS characteristics element. Then, the non-AP STAs can respond with a specific BSR including those details of the buffer as requested by the AP.

QoS BSR operation defines the Trigger Dependent User Info subfield in the user info field of the specific BSRP Trigger frame to indicate the requirement of the format of the specific BSR for the user (the receiver STA of the user info field). It is important to note that in the current IEEE 802.11 ax standard, the Trigger Dependent User Info subfield is empty in BSRP trigger frame. When QoS BSR operation is used, AP sends a specific BSRP trigger frame with Trigger Dependent User Info subfield in the user info field to request specific information of the buffer status of the user which could help AP or its affiliated MLD allocate channel resource for the transmission of the non-AP STAs which sends BSRs and satisfies the QoS requirement of those transmission. It should be noted that the AP can use a reserved value in the trigger type field in the common info field of the trigger frame to indicate that the trigger frame is a specific BSRP trigger frame under QoS BSR operation (a BSRP trigger frame with the requirement of the format of the BSR for the user). Then, legacy STAs will not parse the trigger dependent user info in the BSRP trigger frame under QoS BSR operation.

The QoS BSR operation defines a new BSR control subfield, denoted by QoS BSR control subfield, to allow the non-AP STA to report QoS status of the buffer in the specific BSR, such as expiration time of the MSDU lifetime, or delay bound as indicated in the corresponding QoS characteristics element.

### 5. Flow Diagrams

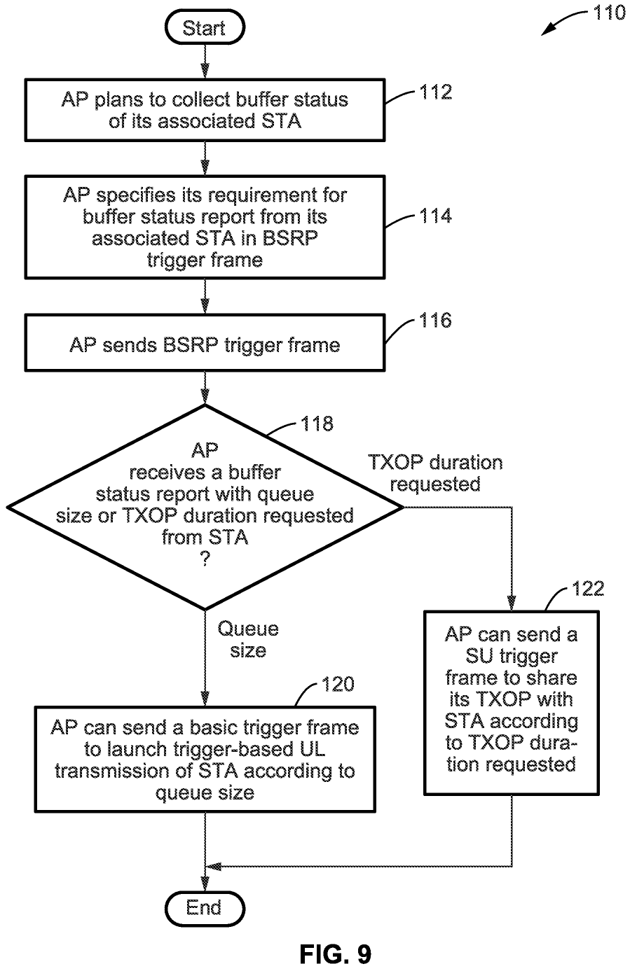

FIG. 9 illustrates an example embodiment 110 of an AP sending a specific BSRP to request a specified buffer status report from its associated STAs. When the AP determines 112 to collect buffer status from its associated STAs, it specifies 114 its requirement for a specific buffer status report from its associated STA in a specific BSRP trigger frame. Then the AP sends 116 the specific BSRP trigger frame.

A check 118 determines if the non-AP STA has received a report of TXOP duration requested of its buffer to the AP. If it has received the report, then at block 122 the AP can send a Single User (SU) trigger frame, such as in a Multiple-User (MU) Ready-To-Send (RTS) TXS frame to share a TXOP with a non-AP STA according to the TXOP duration requested.

Otherwise, if at block 118 it was found that the non-AP STA reported queue size to the AP, then at block 120 the AP can send a basic trigger frame to trigger UL traffic from the non-AP according to the queue size.

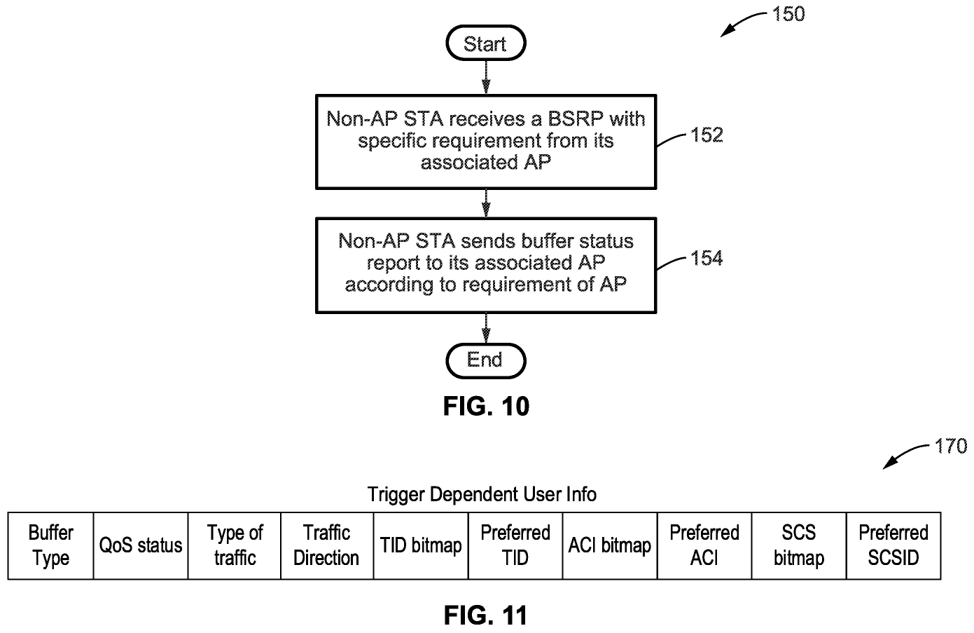

FIG. 10 illustrates an example embodiment 150 of a non-AP STA sending a BSR to report its buffer status after it receives a specific BSRP with specific requirement from its associated AP. The non-AP STA receives 152 a specific BSRP containing specific requirements from its associated AP. In response to this, the non-AP STA sends a specific buffer status report (BSR) to the AP according to the requirements of the AP. The specific buffer status report (BSR) can utilize the format exemplified in FIG. 11 through FIG. 14, and the QoS control fields described following the description of those figures, as well as the existing QoS control field and BSR control subfield as defined in IEEE 802.11 ax.

### 6. Frame Fields and Subfields

FIG. 11 illustrates an example embodiment 170 of a trigger dependent User Info subfield in the user info field of a specific BSRP Trigger frame. In at least one embodiment, the fields shown in the figure are added to the Trigger dependent user info subfield in the user info field in the specific BSRP trigger frame to indicate the requirement of the BSR of the AP for each user (the intended receiver of the user info field). The AP can set one reserved bit in the user Info field to a first state (e.g., “1”) in the trigger frame as shown in FIG. 4 to indicate the presence of the trigger dependent user info subfield in the user info field when the trigger frame is BSRP.

The subfields of this trigger dependent User Info subfield are as follows. A Buffer Type subfield can be set by the AP to indicate whether the intended receiver of the user info field should report its buffer at the TID level, the AC level, or the traffic stream level. If this field is set to the TID level, then the receiver should send the buffer status per TID. If this field is set to the AC level, then the receiver should send the buffer status per AC. If this field is set to the traffic stream level, then the receiver should send the buffer status per traffic stream, e.g., per SCS traffic stream.

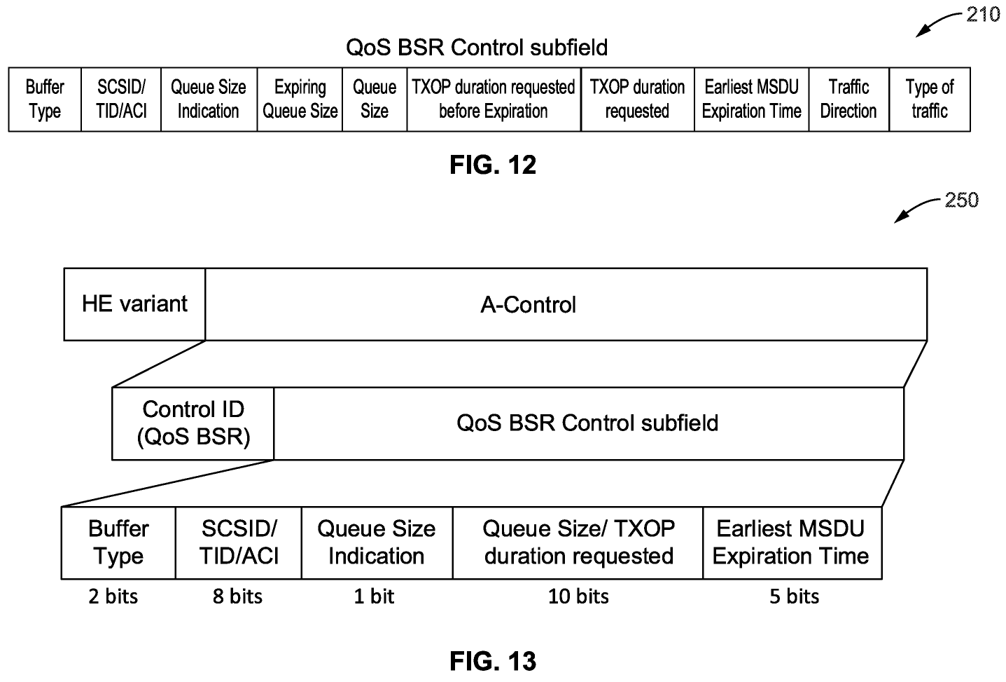

A QoS status subfield can be set by the AP to indicate whether the intended receiver of the user info field should report the QoS status of the buffer in the buffer status report. In at least one embodiment, this field comprises a one bit indication, for example when this bit is set to a first state (e.g., “1”), then the receiver should report the QoS status of the buffer in the BSR. For example, the receiver can report the earliest MSDU expiration time of the buffer using QoS BSR Control subfield as shown in FIG. 12 or QoS Control field for QoS BSR in the HT control field as shown in FIG. 13.

A Type of traffic subfield can be set by the AP to indicate which type of traffic whose buffer should be reported in the BSR. For example, this field can be set to “latency sensitive traffic” or “all types of traffic”, “EPCS traffic” (as defined in IEEE 802.11 be). When this field is set to “latency sensitive traffic” (or “EPCS traffic”), then the receiver of this field should only report the buffer status of latency sensitive traffic (or “EPCS traffic”, respectively). If this field is set to “all types of traffic”, then the receiver of this field should report the buffer status of all types of traffic.

A Traffic Direction subfield is set by the AP to indicate which direction of traffic whose buffer should be reported in the BSR. For example, this field can be set to “UL and P2P”, “P2P only”, and “UL only”. When the receiver of this field reports buffer status of the UL traffic only, it may report queue size in terms of bytes (or bits). When the receiver of this field reports buffer status of the traffic including the P2P traffic, it may report TXOP duration requirements for transmitting the reported traffic. If this field is set to “UL and P2P”, then the receiver of this field should report the buffer status of UL and P2P traffic. If this field is set to “UL only”, then the receiver of this field should only report the buffer status of UL traffic. If this field is set to “P2P only”, then the receiver of this field should report the buffer status of only the P2P traffic.

A TID bitmap subfield is set by the AP to indicate which TIDs whose buffer should be reported in the specific BSR. Each bit in this field represents a TID. When the bit is set to a first state (e.g., “1”), then the receiver of this field should report the buffer status of the TID with respect to this bit. Otherwise, the bit is set to a second state (e.g., “0”), and the receiver of this field may not report the buffer status of the TID with respect to this bit.

A Preferred TID subfield is set by the AP to indicate which TID whose buffer must be reported in the BSR. The receiver of this field has to report the buffer status of the TID indicated in this field in the BSR.

An ACI bitmap subfield is set by the AP to indicate which ACs whose buffer should be reported in the specific BSR. Each bit in this field represents an AC. When the bit is set to a first state (e.g., “1”), then the receiver of this field should report the specific buffer status of the AC with respect to this bit. Otherwise, if the bit is set to a second state (e.g., “0”), then the receiver of this field may not report the buffer status of the AC with respect to this bit.

A Preferred ACI subfield is set by the AP to indicate which AC whose buffer must be reported in the specific BSR. The receiver of this field has to report the buffer status of the AC indicated in this field in the specific BSR.

A SCS bitmap subfield is set by the AP to indicate which SCSs whose buffer should be reported in the BSR. Each bit in this field represents a SCS. When the bit is set to a first state (e.g., “1”), then the receiver of this field should report the buffer status of the SCS with respect to this bit. Otherwise, if the bit is set to a second state (e.g., “0”), then the receiver of this field is not to report the buffer status of the SCS with respect to this bit.

A Preferred SCSID subfield is set by the AP to indicate which SCS whose buffer must be reported in the BSR. The receiver of this field has to report the buffer status of the SCS indicated in this field in the BSR.

In at least one embodiment / mode / option the fields of TID bitmap and Preferred TID are only present when the buffer type field is set to the TID level. In at least one embodiment / mode / option the fields of the ACI bitmap and Preferred ACI are only present when the buffer type field is set to the AC level. In at least one embodiment / mode / option the fields of SCS bitmap and Preferred SCSID are only present when the buffer type field is set to SCS level.

It should be noted that the subfield shown in the figure can also be the Trigger Dependent Common Info subfield in the BSRP Trigger frame; which is set by the AP to indicate its specific requirement of the BSRs for all the intended receivers of the specific BSRP trigger frame. If the fields in FIG. 11 become the trigger dependent common info subfield, then the AP can use one reserved bit in the common info field in the specific BSRP trigger frame and set this one reserved bit to a first state (e.g., “1”) to indicate the presence of the trigger dependent common info subfield as shown in FIG. 4 in the common info field in the specific BSRP trigger frame.

FIG. 12 illustrates an example embodiment 210 of a new BSR control subfield, denoted by QoS BSR control subfield, in the HT control field in a MAC frame to report buffer status with more information compared with the current BSR control subfield in IEEE 802.11 ax.

The figure depicts example fields that can be included in the QoS BSR control subfield according to the present disclosure as described below.

A Buffer Type field is set by the non-AP STA to indicate the format of SCSID / TID / ACI field. When this field is set to a value indicating “SCS”, then the SCSID / TID / ACI field is set to represent an SCS. When this field is set to a value indicating “TID”, then the SCSID / TID / ACI field is set to represent a TID. When this field is set to a value indicating “AC”, then the SCSID / TID / ACI field is set to represent an AC.

If a SCSID / TID / ACI field is set by the non-AP STA to represent a SCS, then the receiver can recognize that the buffer status reported in the same QoS BSR Control subfield is for buffer status of the SCS. If non-AP STA sets this field to represent a TID, then the receiver can recognize that the buffer status reported in the QoS BSR Control subfield is for buffer status of the TID. If a non-AP STA sets this field to represent an AC, then the receiver can recognize that the buffer status reported in the QoS BSR Control subfield is for buffer status of the AC.

A Queue Size Indication field is set by the non-AP STA to indicate whether the buffer status in the QoS BSR Control subfield is reported in terms of TXOP duration or Queue Size. For example, if this field is set to a first state (e.g., “1”), then the buffer status is reported in terms of TXOP duration which can be indicated in the TXOP duration requested before the Expiration field and the TXOP duration requested field. If this field is set to a first state (e.g., “1”), then the buffer status is reported in terms of bytes which could be indicated in the Expiring queue size field and queue size field.

An Expiring Queue Size field is set by the non-AP STA to indicate the queue size (buffer size) that will be expired by the earliest MSDU expiration time (or the queue size that is required to be transmitted by the earliest MSDU expiration time). The AP receiving this field should finish the buffer reported in this field before the earliest MSDU expiration time. It should be noted that the Expiring Queue Size field can represent a partial queue size of the traffic indicated in the SCSID / TID / ACI field.

A Queue Size field is set by the non-AP STA to indicate the total queue size (in terms of bits) of the traffic indicated in the SCSID / TID / ACI field that is reported in the QoS BSR subfield. The AP receiving this field can arrange the trigger-based transmission for the traffic reported in this field.

A TXOP duration requested before Expiration field is set by the non-AP STA to indicate the TXOP duration it is requesting so that it may complete traffic transmission that will be expired by the earliest MSDU expiration time. The AP receiving this field should trigger a TXOP sharing (e.g., triggered TXOP sharing procedure as defined in IEEE 802.11 be) with the non-AP STA and shares the TXOP duration indicated in this field before the earliest MSDU expiration time. For example, this field could be set to a value, for instance in units of milliseconds or microseconds, to represent the channel time (e.g., in units of milliseconds or microseconds) that the non-AP STA requires the AP to share TXOP with it on a 20 MHz channel bandwidth. The AP may vary the TXOP sharing time with the non-AP, depending on the exact BW utilized by the AP sharing the TXOP with the non-AP STA. In at least one embodiment / mode / option this field can be set to a value, for instance in units of milliseconds, to represent the channel time (e.g., in units of milliseconds or microseconds) over the channel bandwidth of the current TXOP. For example, if the TXOP holder is occupying x MHz channel BW, then the non-AP sets the value of this field, e.g., y ms, to represent that it requires y ms TXOP sharing time over x MHz channel BW. If the AP can only share TXOP over z MHz channel BW later, it may share TXOP time with y/x*z ms.

A TXOP duration requested field is set by the non-AP STA to indicate the TXOP duration it is requesting so that it may complete the transmission of all the traffic that is indicated in the SCSID / TID / ACI field of the QoS BSR subfield. The AP receiving this field can trigger a TXOP sharing (e.g., triggered TXOP sharing procedure as defined in IEEE 802.11 be) with the non-AP STA and shares the TXOP duration indicated in this field. The value of this field can be similar to the TXOP duration requested before Expiration field.

An Earliest MSDU Expiration Time field is set by the non-AP STA to indicate the earliest expiration time of the MSDU lifetime (or latency bound) of the buffer reported in the QoS BSR control field. The AP receiving this field should arrange the transmission before the earliest MSDU expiration time to let the MSDU be transmitted before its lifetime expires (or before latency bound is reached). In at least one embodiment / mode / option this field is set to the remaining time before the MSDU expires (or before latency bound is reached) since the frame carrying the QoS BSR control subfield is received by the AP. Alternatively, in at least one embodiment / mode / option this field is set to the TSF time of the AP at which time an MSDU would expire in the buffer. When this field is set to TSF time, some least significant bits and some most significant bits may not be included in this field due to limited bit size. If so, then those least significant bits are considered as zeros (or ones). TSF time represents the nearest future time that matches the bits in the field plus those least significant bits not included in the field.

A Traffic Direction field is set by the non-AP to indicate the direction of the traffic reported in the QoS BSR control subfield. For example, this field can be set to a value for at least indicating “UL and P2P”, “P2P only”, and “UL only”. When the station receiving this field reports buffer status of the UL traffic only, it may report queue size in terms of bytes (or bits). When the station receiving of this field reports buffer status of the traffic including the P2P traffic, it may report TXOP duration it needs to transmit the traffic reported.

If this field is set to “UL and P2P”, then the receiver of this field knows the QoS BSR control subfield reports the buffer status of UL and P2P traffic.

If this field is set to “UL only”, then the receiver of this field knows the QoS BSR control subfield reports the buffer status of UL traffic only.

If this field is set to “P2P only”, then the receiver of this field knows the QoS BSR control subfield reports the buffer status of P2P traffic only.

Type of traffic: non-AP STA sets this field to indicate which type of traffic is reported in the QoS BSR Control subfield. For example, this field can be set to “latency sensitive traffic” or “all types of traffic” or “EPCS traffic”. When this field is set to “latency sensitive traffic” (or “EPCS traffic”), then the receiver of this field will recognize that the QoS BSR control field only reports the buffer status of latency sensitive traffic (or EPCS traffic, respectively). If this field is set to “all types of traffic”, then the receiver of this field will recognize that the QoS BSR control field reports the buffer status of all types of traffic.

FIG. 13 illustrates an example embodiment 250 of a specific QoS BSR control subfield. Due to the limited length of the HT control field, QoS BSR control subfield cannot be longer than 26 bits if it is carried in the A-Control subfield of the HT control field. Then, in this instance only some of the fields as shown in this figure may be utilized in the QoS BSR control subfield.

The Control ID field in the A-control subfield can be set to indicate that there is a QoS BSR control subfield following it. Inside the QoS BSR control subfield, it contains buffer type field, SCSID / TID / ACI field, Queue Size Indication field, Queue Size / TXOP duration requested field (or expiring queue size / TXOP duration requested before expiration field), Earliest MSDU Expiration time field; as explained in previous sections. The following should be noted.

Queue Size indication is set to indicate whether the Queue Size / TXOP duration requested field represents a Queue Size field or a TXOP duration requested field. For example, if this field is set to a first state (e.g., “1”), then the Queue Size / TXOP duration requested field represents a Queue Size field. Otherwise, this field is set to a second state (e.g., “0”) and the Queue Size / TXOP duration requested field represent a TXOP duration requested field. The bits in the figure represent the length of each field in the QoS BSR Control subfield. It will be noted that the Queue size / TXOP duration requested field is exemplified using 10 bits for establishing queue size. Implementations of the present disclosure may be configured with these bits being utilized as a single size value or as a scaling value plus a size value. It should be appreciated that the sizing of the queue can utilize any desired number of bits and format without departing from the teachings of the present disclosure.

It should be noted that the QoS BSR control subfield can be transmitted the same as the BSR control field. It should also be noted that multiple values in the Control ID field can be used to indicate different types of QoS BSR Control subfields. Each value in the Control ID field represents one different QoS BSR control subfield.

In at least one embodiment / mode / option when a non-AP STA reports the Queue size in the QoS BSR control subfield, it is expected to: (a) receive at least one TF from the AP before the earliest MSDU Expiration time indicated in the QoS BSR control subfield, and/or (b) finish the transmission of the buffer indicated in the Queue size subfield before the earliest MSDU Expiration time.

In at least one embodiment / mode / option when a non-AP STA reports the TXOP duration requested in the QoS BSR control subfield, it is expected to: (a) receive a MU RTS TXS trigger frame from AP before the earliest MSDU Expiration time indicated in the QoS BSR control subfield, and/or (b) receive one or more periods of triggering TXOP sharing time (which is allocated by MU RTS TXS trigger frame from AP) as indicated in TXOP duration request subfield in the QoS BSR control subfield whereby the end time of the last period of triggering TXOP sharing time is earlier than the earliest MSDU Expiration time.

### 6.1. QoS Control Field

In at least one embodiment / mode / option the QoS control field can be used to carry QoS status; as exemplified below. Formats are described below for QoS control fields for QoS BSR based on application frame type. In each of these instances Bits 0-3 are for TID and Bits 5-6 are for Ack policy indication.
(1) QoS Null frame sent in a non-mesh BSS by non-AP STAs that are not a TPU buffer STA or a TPU Sleep STA:
   If Bit 4 = 0: Bit 7 = 0; and bits 8-15 = TXOP Duration Requested;
   If Bit 4 = 1: Bit 7 = 0; and bits 8-15 = Queue size; and
   If Bit 4 = reserved: when Bit 7 = 1; then bits 8-15 = MSDU expiration time.
(2) QoS R-TWT Data/Null frame transmitted by non-AP STA:
   Bit 4 = More Data;
   If Bit 7 = 0, then bits 8-15 = TXOP Duration Requested and MSDU expiration time;
   If Bit 7 = 1, then bits 8-15 = Queue size and MSDU expiration time.

Thus, in option (1) above, the QoS control field can be reused in the QoS Null frame sent in a non-mesh BSS by non-AP STAs that are not a TPU buffer STA or a TPU Sleep STA. As described above, when setting the reserved Bit 7 to a first state (e.g., “1”), then bits 8-15 can be used to indicate the MSDU expiration time of the buffer of the TID indicated in Bit 0-3.

Then in option (2) a new application frame type is used to carry buffer status. For example, a QoS R-TWT Data / Null frame is defined as a new application frame type. In this instance, If Bit 7 is set to a second state (e.g., “0”), then Bits 8-15 can be used to indicate the TXOP duration requested and MSDU expiration time of the buffer of the TID indicated in Bits 0-3.

If bit 7 is set to a first state (e.g., “1”), then Bits 8-15 can be used to indicate the Queue size and MSDU expiration time of the buffer of the TID indicated in Bits 0-3.

It will be noted that Bit 4 can be used to indicate whether the transmitter of this field has more data to transmit during a R-TWT SP. For example, if more data is set to a first state (e.g., “1”), then the transmitter of this field does not have data to transmit during the R-TWT SP. In at least one embodiment / mode / option, when the More data field is set to a first state (e.g., “1”), the Bits 5-15 can be reserved or used for other purposes. Otherwise, when this More data field is set to a second state (e.g., “0”).

Instead of using Bit 4 as “More data” field, in at least one embodiment / mode / option Bit 4 can be used to indicate whether the frame carries latency sensitive traffic or not. If it is set to a first state (e.g., “1”), then the frame carries latency sensitive traffic. Otherwise, this field is set to a second state (e.g., “0”) indicating that the frame does not carry latency sensitive traffic.

It should be noted that the Ack Policy Indicator can be identical to that defined in IEEE 802.11.

### 7. Communication Examples

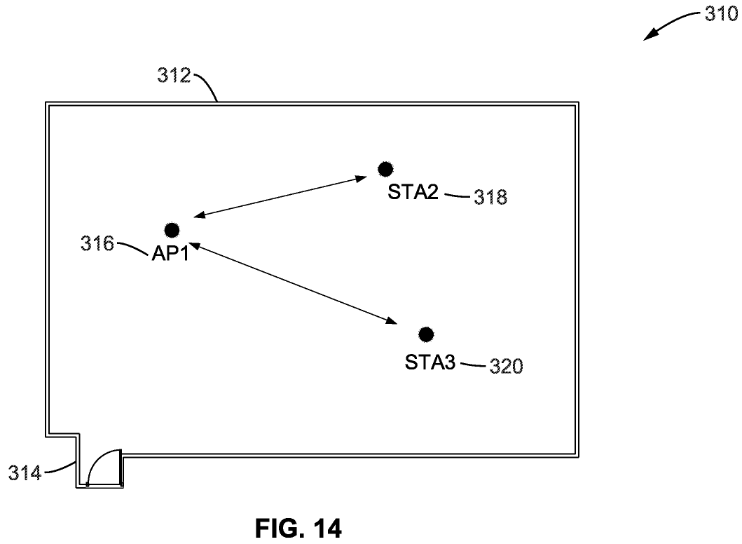

FIG. 14 illustrates an example network topology 310 utilized for the following example cases. It should be appreciated that the topology is utilized by way of example and not limitation, as the teachings of the present disclosure are not limited to any specific network topology.

The example topology depicts a single AP (AP1) 316 and multiple STAs, depicted as STA2 318 and STA3 320 that are associated with AP1. By way of example the topology is shown in an area 312 (depicted as room 312 having with apertures (doors/windows) 314). It should be appreciated that AP1 may be affiliated with a Multi-Link Device (MLD); while STA2 and/or STA3 may also be affiliated with an MLD. In the examples, AP1 is able to send a specific BSRP frame containing specific requirements for the BSR. The specific requirement for each user can be carried in the trigger dependent user info subfield in the user info field in the BSRP trigger frame. The format of trigger dependent user info subfield was shown in FIG. 11.

In the examples, STA2 and STA3 are able to send a frame carrying the BSR or QoS BSR control subfield in the HT control field and/or the QoS control field. The format of QoS BSR control subfield is shown in FIG. 12 and FIG. 13. The format of QoS control field could be the same as defined in IEEE 802.11 or as described in Section 6.1. The format of BSR control subfield can be the same as in the IEEE 802.11 ax.

Table 1 exemplifies buffer status for non-AP STAs in the following examples.

### 7.1. Example 1: AP1 Collecting SCS2 Buffer Status w/QoS Status

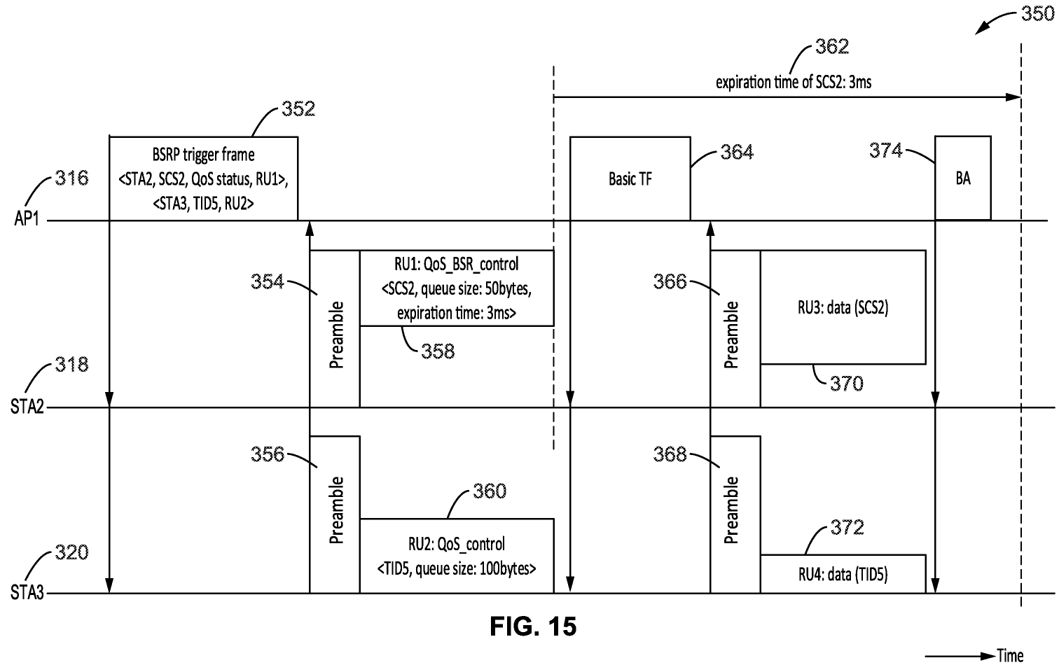

FIG. 15 illustrates an example embodiment 350 of AP1 sending a specific BSRP trigger frame with specific requirements for the specific BSR. In this example the interaction is between AP1 316, STA2 318 and STA 320.

AP1 sends a specific BSRP trigger frame 352 to request STA2 to send its buffer status of SCS2 traffic stream with QoS status over RU1 and STA3 to its buffer status of TID5 over RU2.

After STA2 receives the specific BSRP trigger frame, it sends a QoS Null frame with preamble 354 and having an HT control field carrying a QoS BSR control subfield through RU1 358. In the QoS specific BSR control subfield, STA2 reports that it has 50 bytes of SCS2 traffic in the buffer and the earliest MSDU lifetime expiration time 362 of SCS2 traffic is in 3 ms.

After STA3 receives the BSRP trigger frame, it sends a QoS null frame with preamble 356 and a QoS control field carrying the buffer status report through RU2 360. In the QoS control field, it reports that it has 100 bytes TID5 traffic in the buffer.

According to the buffer status reports from STA2 and STA3, AP1 should arrange the transmission for the traffic reported in the BSRs. Especially, since the earliest MSDU lifetime expiration time of SCS2 is in 3 ms,

AP1 in this example finishes the transmission of SCS2 in 3 ms in order to avoid the expiration of MSDUs in SCS2. Hence, AP1 sends a TF 364. In response, STA2 sends UL traffic for SCS2, having preamble 366 and RU3 data 370; and STA3 sends preamble 368 with RU4 372 having TID5. It should be noted that AP1 allocated more resources for the traffic of SCS2 of STA2 (i.e., RU3) than for the traffic of TID5 of STA3 (i.e., RU4), as can be seen by their relative sizes in the figure. After receiving these transmissions, AP1 responds with a BA 374.

### 7.2. Example 2: STA Reports TXOP Duration Requested for P2P Traffic in its Buffer

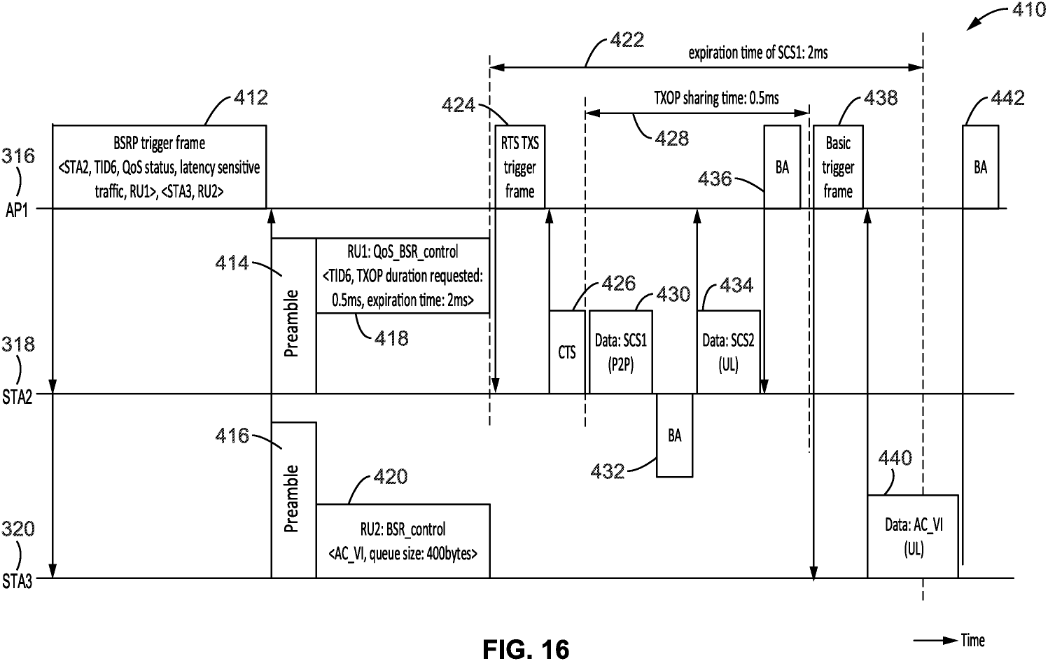

FIG. 16 illustrates an example embodiment 410 of a STA reporting TXOP duration requested for P2P traffic in its buffer. As in the previous figure, the interaction is between AP1 316, STA2 318 and STA3 320.

AP1 sends a specific BSRP trigger frame 412 to request STA2 to report its buffer status of the latency sensitive traffic of TID6 with QoS status, and for STA3 to report its buffer status.

After STA2 receives the specific BSRP trigger frame, it sends a QoS null frame, shown with preamble 414 and with RU1 418 having QoS BSR control subfield in the HT control field through RU1 to report its buffer status as requested by AP1. The QoS BSR control subfield indicates that STA2 has latency sensitive traffic of TID6 (i.e., SCS1 and SCS2) in its buffer. Since the latency sensitive traffic of TID6 contains P2P traffic (i.e., SCS1), the QoS BSR control subfield reports the TXOP duration it requests within which to transmit the latency sensitive traffic of TID6 in its buffer. Also, the QoS BSR control subfield indicates that there is at least one MSDU of the latency sensitive traffic of TID6 that will expire 422 in 2 ms.

After STA3 receives the BSRP trigger frame, it realizes that the AP has not specified any requirements for the BSR. Thus, it sends a QoS null frame with preamble 416 and RU2 420 carrying the legacy BSR control subfield in the HT control field back to AP1. It reports that it only has 400 bytes AC_VI traffic in the buffer.

Due to the MSDU expiration time reported by STA2, AP1 sends a RTS TXS trigger frame 424 to launch a trigger TXOP sharing with STA2. After STA2 responds with CTS frame 426, it is provided in this example a sharing time 428 of 0.5 ms of the TXOP time as shared by AP1 to transmit its latency sensitive traffic P2P data of SCS1 430 and UL data of SCS2 434. It should be noted that the BA 432 in response to the data frame of SCS1 is sent by a non-AP STA which is not AP1. Then in response to UL SCS2 434, AP1 sends BA 436.

Then, AP1 sends a basic trigger frame 438 to trigger the UL transmission 440 of STA3 for traffic buffer reporting. Upon receipt of the UL AP1 responds with BA 442.

### 7.3. Example 3: AP Requesting Buffer Status for P2P Traffic Only

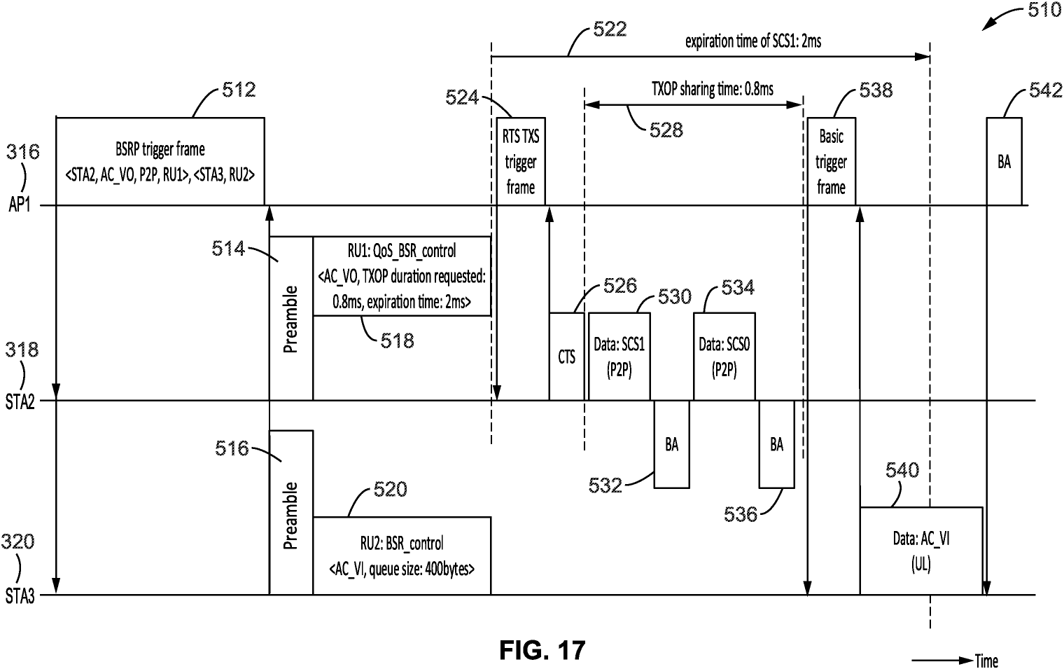

FIG. 17 illustrates an example embodiment 510 of an AP requesting buffer status for P2P traffic only. As in the previous figure, the interaction is between AP1 316, STA2 318 and STA 320.

AP1 sends a specific BSRP trigger frame 512 to request BSRs from STA2 and STA3. AP1 requests STA2 to report its buffer status of the P2P traffic of AC_VO, and for STA3 to report its buffer status with no specific requirement.

In response to the TF, STA2 sends its buffer status report shown with preamble 514, in a frame in RU1 518 carrying the QoS BSR subfield in the HT control field to indicate its buffer status. The QoS BSR subfield indicates that STA2 has the P2P traffic of AC_VO (i.e., SCS0 and SCS1) in its buffer and requesting an 0.8 ms TXOP duration 528 to transmit those P2P traffic of AC_VO. In addition, the earliest MSDU expiration time in that P2P traffic is 2 ms 522.

After STA3 receives the BSRP trigger frame, it realizes that the AP has not specified any requirements for the BSR. Thus, it sends a QoS null frame having preamble 516 and carrying in RU2 520 with the legacy BSR control subfield in the HT control field back to AP1. It reports that it only has 400 bytes AC_VItraffic in the buffer.

Then, AP1 first sends a RTS TXS trigger frame 524 to launch a triggered TXOP sharing with STA2 to ensure the P2P traffic of AC_VO of STA2 can be transmitted in 2 ms. The RTS TXS trigger frame allocates 0.8 ms TXOP sharing time 528 to STA2. After STA2 responds with a CTS frame 526, STA2 starts to transmit the P2P traffic of AC_VO. Since the traffic of SCS1 is latency sensitive but the traffic of SCS0 is not latency sensitive, STA2 transmits the traffic of SCS1 530 earlier than the traffic of SCS0 534. After receiving these transmissions, AP1 responds with BAs 532 and 536.

Next, AP1 triggers 538 the UL transmission of STA3 for the traffic buffer reported by STA3. In response to this TF, STA3 responds by sending UL Data 540; to which AP1 responds with a BA 542.

### 7.4. Example 4: AP Requesting Buffer Status of Multiple ACs

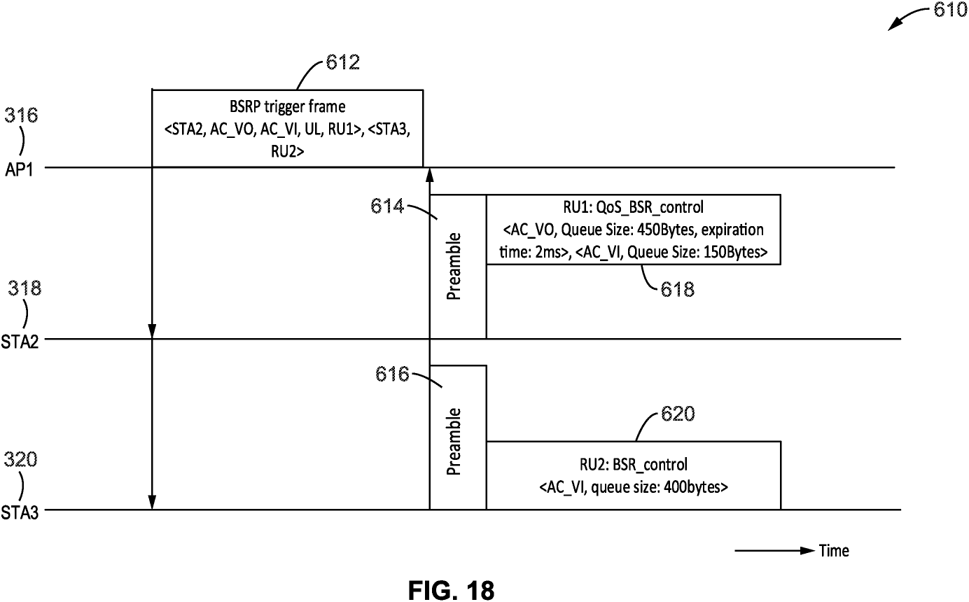

FIG. 18 illustrates an example embodiment 610 of an AP sending a specific BSRP trigger frame to request buffer status of multiple ACs. As in the previous figure, the interaction is between AP1 316, STA2 318 and STA 320.

The AP can specify which ACs whose buffer status it would like information on in the BSRP trigger frame. AP1 sends a specific BSRP trigger frame 612 and specifies that it needs the buffer status report of the UL traffic of AC_VO and AC_VIfrom STA2. AP1 also requests buffer status report from STA3 in the BSRP trigger frame but does not specify any special requirements.

In response to this TF, STA2 sends two frames within this transmission in the TB PPDU to report its buffer status of AC_VO and AC_VI. This transmission is seen with preamble 614 and using RU1 618. Each frame carries the QoS BSR control subfield in the HT control field. The first frame reports 450 bytes UL traffic of AC_VO in its buffer. Since there is latency sensitive traffic in the UL traffic of AC_VO (i.e., SCS2), the QoS BSR control subfield also indicates the earliest MSDU expiration time for the buffer is 2 ms. The second frame indicates 150 bytes UL traffic of AC_VIin the buffer.

Since there is no specific requirements given it from AP1, STA3 sends a frame with preamble 616 and RU2 620 carrying a legacy BSR control subfield in the HT control field to report its 400 bytes UL traffic buffer.

Then AP1 can arrange the transmission for STA2 and STA3 according to the buffer status reports it receives from STA2 and STA3 (not shown in the figure).

### 7.5. Example 5: QoS Control Field for Buffer Status Report per TID with QoS Status

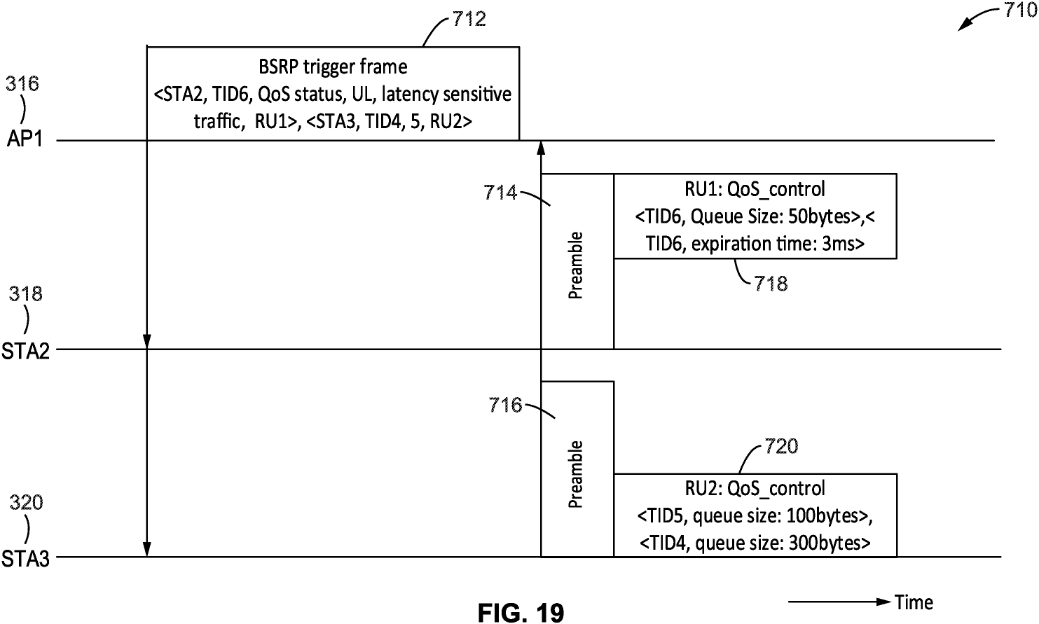

FIG. 19 illustrates an example embodiment 710 of a PPDU carrying multiple frames with QoS control fields. As in the previous figure, the interaction is between AP1 316, STA2 318 and STA 320.

The QoS control fields in the same PPDU can be used for the buffer status report of the same TID as well as the buffer status reports of the different TIDs.

When AP1 sends a BSRP trigger frame 712, it requests STA2 to report the buffer status of its UL latency sensitive traffic of TID6 with QoS status. AP1 also requests STA3 to report the buffer status of its traffic of TID4 and TID5.

STA2 sends a TB PPDU carrying two frames as a transmission with preamble 714 and RU1 718. Each frame carries the QoS control field. One QoS control field reports that the queue size of the UL latency sensitive traffic of TID6 (i.e., SCS2) in the buffer of STA2 is 50 bytes. The other QoS control field reports that at least one MSDU of the UL latency sensitive traffic of TID6 will expire in 3 ms.

STA3 also sends two frames in the TB PPDU in response to the BSPR trigger frame. This transmission is shown with preamble 716 and RU2 720. One frame carries the QoS control field which reports its buffer status of TID5, and the other frame carries the QoS control field which reports its buffer status of TID6.

Then AP1 can arrange the transmission for STA2 and STA3 according to the buffer status reports it receives from STA2 and STA3 (not shown in the figure).

### 8. Additional Description of Embodiments

If UL TIDs of an AC at a non-AP MLD are mapped to different sets of setup links and buffer status of any of the TIDs is not provided to an AP MLD, the different sets should have at least a common setup link for the AP MLD to solicit TB PPDUs for the TIDs if there is a (setup/enabled) link between the non-AP MLD and the AP MLD to which all the (UL) TIDs of the AC is not mapped (and buffer status of any of the TIDs is not provided to an AP MLD).

In at least one embodiment / mode / option the (UL) TIDs are always mapped to the same AC to the same set of links in the UL direction if there is a (setup/enabled) link between the non-AP MLD and the AP MLD to which all the (UL) TIDs of the AC is not mapped (and buffer status of any of the TIDs is not provided to an AP MLD).

In at least one embodiment / mode / option one MPDU (e.g., QoS Null frame) can carry one BSR (or QoS BSR) in the A-control field of the HE variant HT control field and one QoS control field (carrying queue size or TXOP duration requested) at the same time. In the BSR, the ACI High could be set to an AC and the queue size High can be set to the buffer status of the AC. Meanwhile, the TID field of the QoS control field is set to one TID of the AC and the corresponding queue size is set to the queue size of that TID. When the AP receives this MPDU, it thus knows the queue size of the other TID of the AC is (queue size of the ACI High in BSR - queue size of the TID in QoS control field).

In at least one embodiment / mode / option the buffer status report in the QoS control field is not subject to the TID-to-Link mapping. For example, a QoS null frame carrying the queue size or TXOP duration request of a TID in the QoS control field can be transmitted over any link, even if the TID indicated in the QoS control field is not mapped to that link.

In at least one embodiment / mode / option that only the BSR or QoS BSR reports the buffer status of the TIDs that is mapped to the link where the BSR is transmitted.

In at least one embodiment / mode / option only BSR or QoS BSR report the buffer status of the TIDs that the non-AP STA expects to let AP trigger over the link where the BSR or QoS BSR is transmitted. The buffer status reported to the AP can be less than that in the buffer of the non-AP STA.

In at least one embodiment / mode / option the BSR or QoS BSR of an AC from a non-AP STA can be shared between different links of the AP if the (UL) TID-to-Link mapping of that AC of that non-AP STA on those links is the same.

For example, UL TID6 and TID7 of the non-AP STA are mapped to Link1 and Link2, and only UL TID6 of the non-AP STA is mapped to Link3 and Link4. Then, the AP MLD can share the BSR or QoS BSR of AC_VO (received on Link 1 or Link2) (AC for TIDs 6 and 7) of the non-AP STA between Link1 and Link2 (but cannot share with Link3 and Link4). The AP MLD can share the BSR or QoS BSR of AC_VO (received on Link3 or Link4) of the non-AP STA between Link3 and Link4 (but cannot share with Link1 and Link2).

In at least one embodiment / mode / option the AP can allocate different channel resources (e.g., the UL length subfield in the common info field of BSRP, RU allocation subfield, UL HE-MCS subfield in user info field of BSRP) in the BSRP trigger frame to indicate the granularity of the BSR (e.g., AC level or TID level) it expects to receive from the non-AP STA. The non-AP STA should report as many details as possible to the AP using the channel resource allocated by the AP in the BSRP. The non-AP STA should send as many QoS Null frames carrying queue size (or TXOP duration requested) of a TID as possible using the channel resource allocated by BSRP.

For example, if the AP allocates a channel resource(s) in BSRP that allows a non-AP STA to transmit a QoS Null frame carrying BSR subfield in the A-control field of the HE variant HT control field and QoS control field (e.g., queue size of a TID), then the non-AP STA has to respond with a QoS Null frame carrying BSR subfield in A-control field of the HE variant HT control field and QoS control field.

For example, if the AP allocates a channel resource in BSRP that allows a non-AP STA to transmit multiple QoS Null frames (e.g., one QoS Null frame with BSR subfield and QoS control field + three QoS Null frames with QoS control field), then the non-AP STA has to respond with the corresponding number of QoS Null frames.

In at least one embodiment / mode / option only one QoS null frame will carry BSR subfield in response to the BSRP of AP.

In at least one embodiment / mode / option no QoS null frame carries BSR subfield in response to BSRP.

In at least one embodiment / mode / option if the BSR subfield is included in the response to the BSRP, then only one of the QoS control fields of the TIDs of the ACI High subfield in the BSR. For example, if SCI High is AC_VO (corresponding to TID6 and TID7), then the response to the BSRP could only carry the QoS control field of TID6 (or the QoS control field of TID7 instead).

In at least one embodiment / mode / option the QoS control fields should report the buffer status of the TID with higher priority first.

The non-AP STA may only report the QoS control fields of the TIDs that are mapped to the link of the non-AP STA.

The non-AP STA may only report the QoS control fields of the TIDs of which the ACs has at least one TID that is not mapped to the link of the non-AP STA. For example, if TID6 of AC_VO is mapped to the link of the non-AP STA, but TID7 of AC_VO is not, then the non-AP STA can only report the QoS control fields of TID6. If both TID6 and TID7 are mapped to the link, then the non-AP STA does not report the QoS control fields of TID6 or TID7.

### 9. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for wireless communication in a network, the apparatus comprising: (a) a wireless communication circuit, as a wireless station (STA) which is a separate STA or as a STA in a multiple-link device (MLD), and operating as either an Access Point (AP) STA or a non-AC STA, for wirelessly communicating with other wireless stations (STAs) using a carrier sense multiple access/collision avoidance (CSMA/CA) mechanism on a wireless local area network (WLAN); (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol for said wireless communication circuit, comprising: (d)(i) transmitting a specific buffer status request pole (BSRP), from said STA operating as an AP, for a specific buffer status report (BSR) from a non-AP STA; (d)(ii) wherein said specific BSRP comprises specific requirements for a specific BSR which contains information selected from the group of buffer characteristics consisting of: access categories (ACs), traffic identifiers (TIDs), traffic streams, traffic directions, types of traffic and quality of service (QoS) requirements; and (d)(iii) receiving a specific BSR from said non-AP STA containing specific buffer characteristics, by the AP which then arranges transmissions to satisfy QoS requirements.

An apparatus for wireless communication in a network, the apparatus comprising: (a) a wireless communication circuit, as a wireless station (STA) which is a separate STA or as a STA in a multiple-link device (MLD), and operating as either an Access Point (AP) STA or a non-AC STA, for wirelessly communicating with other wireless stations (STAs) using a carrier sense multiple access/collision avoidance (CSMA/CA) mechanism on a wireless local area network (WLAN); (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol for said wireless communication circuit, comprising: (d)(i) receiving a buffer status report (BSR) by said STA operating as an access point (AP), as received from a non-AP STA; (d)(ii) wherein said BSR is either received in response to said AP transmitting a buffer status request to the non-AP STA, or is received as an unsolicited BSR from said non-AP STA; (d)(iii) wherein said BSR contains specific buffer characteristics consisting of: access categories (ACs), traffic identifiers (TIDs), traffic streams, traffic directions, types of traffic and quality of service (QoS) requirements; and (d)(iv) wherein in response to receiving said BSR from said non-AP STA, the AP arranges transmissions to satisfy QoS requirements.

A method of performing wireless communication in a network, comprising: (a) performing wireless communication between stations of a wireless communication network using communications protocol including performing carrier sense multiple access/collision avoidance (CSMA/CA); (b) receiving a specific buffer status report (BSR) from a non-AP STA, by a STA operating as an access point (AP); (c) wherein said specific BSR is either received in response to said AP transmitting a specific buffer status request pole (BSRP) to the non-AP STA, or is received as an unsolicited specific BSR from said non-AP STA; (d) wherein said specific BSR contains specific buffer characteristics consisting of: access categories (ACs), traffic identifiers (TIDs), traffic streams, traffic directions, types of traffic and quality of service (QoS) requirements; and (e) wherein in response to receiving said specific BSR from said non-AP STA, the AP arranges transmissions to satisfy QoS requirements.

The apparatus or method of any preceding implementation, wherein the AP specifies the specific requirements for the specific BSR as being for each user.

The apparatus or method of any preceding implementation, wherein the AP specifies the specific requirements for the specific BSR as being for each user in the trigger dependent user information subfield of the user information field of a BSRP trigger frame.

The apparatus or method of any preceding implementation, wherein the AP specifies the specific requirements for the specific BSR as being for each all users in the trigger dependent common information subfield of the user information field of a BSRP trigger frame.

The apparatus or method of any preceding implementation, wherein said AP specifies in the specific BSRP that it should receive buffer status at an AC level, a TID level, or a traffic stream level.

The apparatus or method of any preceding implementation, wherein said AP specifies in the specific BSRP that it should receive information on type of traffic, as to whether it is latency sensitive traffic or regular traffic which is not latency sensitive.

The apparatus or method of any preceding implementation, wherein said AP specifies in the specific BSRP that it should receive information on the direction of traffic, as to whether it is uplink (UL) traffic, peer-to-peer (P2P) traffic, or both UL and P2P traffic.

The apparatus or method of any preceding implementation, wherein said AP specifies in the specific BSRP that it should receive information on QoS requirements from the non-AP STA.

The apparatus or method of any preceding implementation, wherein said AP specifies in the specific BSRP that the QoS requirement is a medium access control (MAC) service data unit (MSDU).

The apparatus or method of any preceding implementation, wherein upon receiving queue size information on uplink (UL) traffic from the non-AP STA, the AP launches a trigger-based UL transmission for receiving that UL traffic.

The apparatus or method of any preceding implementation, wherein in response to said specific BSRP, the non-AP STA reports a transmit opportunity (TXOP) required time of a traffic stream, a traffic identifier (TID), or an access class (AC).

The apparatus or method of any preceding implementation, wherein said TXOP required time is for either uplink (UL) traffic and/or peer-to-peer (P2P) traffic.

The apparatus or method of any preceding implementation, wherein said TXOP required time is for a traffic stream comprising a stream classification service (SCS) traffic stream.

The apparatus or method of any preceding implementation, wherein upon receiving transmit opportunity (TXOP) required time of the peer-to-peer (P2P) traffic from the non-AP STA, the AP shares TXOP time with the non-AP STA to transmit P2P traffic during this shared TXOP time.

The apparatus or method of any preceding implementation, wherein upon receiving TXOP transmit opportunity (TXOP) required time of uplink (UL) traffic, the AP shares TXOP time with the non-AP STA, for the non-AP STA to transmit UL traffic during the shared TXOP time.

The apparatus or method of any preceding implementation, wherein the AP arranges transmissions to satisfy quality of service (QoS) requirements with the AP completing transmission of traffic, identified by the non-AP STA in its response to the buffer status request, before the medium access control (MAC) service data unit (MSDU) expiration time of the traffic.

The apparatus or method of any preceding implementation, wherein the specific BSR as received from the non-AP STA contains a partial amount of buffer information to the AP, so that the AP only arranges transmissions of the partial amount of buffer that is reported by the non-AP STA.

The apparatus or method of any preceding implementation, wherein the non-AP STA is only allowed to send the specific BSR of a traffic identifier (TID) over a link in response to a request by the AP.

The apparatus or method of any preceding implementation, wherein the non-AP STA is only allowed to use a high throughput (HT) control field to carry the specific BSR information in response to a request by the AP.

The apparatus or method of any preceding implementation, wherein the non-AP STA is allowed to use a quality of service (QoS) control field to carry the specific BSR information in response to a request by the AP.

The apparatus or method of any preceding implementation, further comprising said AP configured for receiving unsolicited BSRs, from the non-AP STA, which contain said specific buffer characteristics, from which the AP can arrange transmissions to satisfy QoS requirements.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ... a”, “has ... a”, “includes ... a”, “contains ... a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly, the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1

Buffer Status of Non-AP STAs in Examples

| Parameter | Example Station | | | | | | | | |
|---|---|---|---|---|---|---|---|---|---|
| | STA2 | | | | | | | STA3 | |
| AC | VO | VO | VO | VO | VO | VI | VI | VI | VI |
| Queue Size/AC | 600 | 600 | 600 | 600 | 600 | 200 | 200 | 400 | 400 |
| TID | 7 | 6 | 6 | 6 | 6 | 5 | 4 | 5 | 4 |
| Queue Size/TID | 200 | 400 | 400 | 400 | 400 | 50 | 150 | 100 | 300 |
| SCSID | N/A | 0 | 1 | 2 | N/A | N/A | N/A | N/A | N/A |
| Queue Size/SCS | N/A | 50 | 100 | 50 | 200 | N/A | N/A | N/A | N/A |
| Traffic Direction | UL | P2P | P2P | UL | UL | P2P | UL | UL | UL |
| Latency Sensitive | No | No | Yes | Yes | No | No | No | No | No |
| Earliest MSDU Expiration | N/A | N/A | 2mS | 3mS | N/A | N/A | N/A | N/A | N/A |

Notes: queue sizes are given in bytes

What is claimed is:

1. An apparatus for wireless communication in a network, the apparatus comprising:
(a) a wireless communication circuit, as a wireless station (STA) which is a separate STA or as a STA in a multiple-link device (MLD), and operating as either an Access Point (AP) STA or a non-AC STA, for wirelessly communicating with other wireless stations (STAs) using a carrier sense multiple access/collision avoidance (CSMA/CA) mechanism on a wireless local area network (WLAN);
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol for said wireless communication circuit, comprising:
(i) transmitting a specific buffer status request pole (BSRP), from said STA operating as an AP, for a specific buffer status report (BSR) from a non-AP STA;
(ii) wherein said specific BSRP comprises specific requirements for a specific BSR which contains information selected from the group of buffer characteristics consisting of: access categories (ACs), traffic identifiers (TIDs), traffic streams, traffic directions, types of traffic and quality of service (QoS) requirements; and
(iii) receiving a specific BSR from said non-AP STA containing specific buffer characteristics, by the AP which then arranges transmissions to satisfy QoS requirements.

2. The apparatus of claim 1, wherein the AP specifies the specific requirements for the specific BSR as being for each user.

3. The apparatus of claim 1, wherein the AP specifies the specific requirements for the specific BSR as being for each user in the trigger dependent user information subfield of the user information field of a BSRP trigger frame.

4. The apparatus of claim 1, wherein the AP specifies the specific requirements for the specific BSR as being for each all users in the trigger dependent common information subfield of the user information field of a BSRP trigger frame.

5. The apparatus of claim 1, wherein said AP specifies in the specific BSRP that it should receive buffer status at an AC level, a TID level, or a traffic stream level.

6. The apparatus of claim 1, wherein said AP specifies in the specific BSRP that it should receive information on type of traffic, as to whether it is latency sensitive traffic or regular traffic which is not latency sensitive.

7. The apparatus of claim 1, wherein said AP specifies in the specific BSRP that it should receive information on the direction of traffic, as to whether it is uplink (UL) traffic, peer-to-peer (P2P) traffic, or both UL and P2P traffic.

8. The apparatus of claim 1, wherein said AP specifies in the specific BSRP that it should receive information on QoS requirements from the non-AP STA.

9. The apparatus of claim 8, wherein said AP specifies in the specific BSRP that the QoS requirement is a medium access control (MAC) service data unit (MSDU).

10. The apparatus of claim 1, wherein upon receiving queue size information on uplink (UL) traffic from the non-AP STA, the AP launches a trigger-based UL transmission for receiving that UL traffic.

11. The apparatus of claim 1, wherein in response to said specific BSRP, the non-AP STA reports a transmit opportunity (TXOP) required time of a traffic stream, a traffic identifier (TID), or an access class (AC).

12. The apparatus of claim 11, wherein said TXOP required time is for either uplink (UL) traffic and/or peer-to-peer (P2P) traffic.

13. The apparatus of claim 11, wherein said TXOP required time is for a traffic stream comprising a stream classification service (SCS) traffic stream.

14. The apparatus of claim 1, wherein upon receiving transmit opportunity (TXOP) required time of the peer-to-peer (P2P) traffic from the non-AP STA, the AP shares TXOP time with the non-AP STA to transmit P2P traffic during this shared TXOP time.

15. The apparatus of claim 1, wherein upon receiving TXOP transmit opportunity (TXOP) required time of uplink (UL) traffic, the AP shares TXOP time with the non-AP STA, for the non-AP STA to transmit UL traffic during the shared TXOP time.

16. The apparatus of claim 1, wherein the AP arranges transmissions to satisfy quality of service (QoS) requirements with the AP completing transmission of traffic, identified by the non-AP STA in its response to the buffer status request, before the medium access control (MAC) service data unit (MSDU) expiration time of the traffic.

17. The apparatus of claim 1, wherein the specific BSR as received from the non-AP STA contains a partial amount of buffer information to the AP, so that the AP only arranges transmissions of the partial amount of buffer that is reported by the non-AP STA.

18. The apparatus of claim 1, wherein the non-AP STA is only allowed to send the specific BSR of a traffic identifier (TID) over a link in response to a request by the AP.

19. The apparatus of claim 1, wherein the non-AP STA is only allowed to use a high throughput (HT) control field to carry the specific BSR information in response to a request by the AP.

20. The apparatus of claim 1, wherein the non-AP STA is allowed to use a quality of service (QoS) control field to carry the specific BSR information in response to a request by the AP.

21. The apparatus of claim 1, further comprising said AP configured for receiving unsolicited BSRs, from the non-AP STA, which contain said specific buffer characteristics, from which the AP can arrange transmissions to satisfy QoS requirements.

22. An apparatus for wireless communication in a network, the apparatus comprising:
(a) a wireless communication circuit, as a wireless station (STA) which is a separate STA or as a STA in a multiple-link device (MLD), and operating as either an Access Point (AP) STA or a non-AC STA, for wirelessly communicating with other wireless stations (STAs) using a carrier sense multiple access/collision avoidance (CSMA/CA) mechanism on a wireless local area network (WLAN);
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol for said wireless communication circuit, comprising:
(i) receiving a buffer status report (BSR) by said STA operating as an access point (AP), as received from a non-AP STA;
(ii) wherein said BSR is either received in response to said AP transmitting a buffer status request to the non-AP STA, or is received as an unsolicited BSR from said non-AP STA;
(iii) wherein said BSR contains specific buffer characteristics consisting of: access categories (ACs), traffic identifiers (TIDs), traffic streams, traffic directions, types of traffic and quality of service (QoS) requirements; and
(iv) wherein in response to receiving said BSR from said non-AP STA, the AP arranges transmissions to satisfy QoS requirements.

23. A method of performing wireless communication in a network, comprising:
(a) performing wireless communication between stations of a wireless communication network using communications protocol including performing carrier sense multiple access/collision avoidance (CSMA/CA);
(b) receiving a specific buffer status report (BSR) from a non-AP STA, by a STA operating as an access point (AP);
(c) wherein said specific BSR is either received in response to said AP transmitting a specific buffer status request pole (BSRP) to the non-AP STA, or is received as an unsolicited specific BSR from said non-AP STA;
(d) wherein said specific BSR contains specific buffer characteristics consisting of: access categories (ACs), traffic identifiers (TIDs), traffic streams, traffic directions, types of traffic and quality of service (QoS) requirements; and
(e) wherein in response to receiving said specific BSR from said non-AP STA, the AP arranges transmissions to satisfy QoS requirements.
